(19) United States
(12) Patent Application Publication
(10) Pub. No.: US 2002/0003882 A1
(43) Pub. Date: Jan. 10, 2002

(54) Method of, and means for, delivering information services over the air

(76) Inventor: Barry Jones, Warrington (GB)

Correspondence Address: U.S. Philips Corporation, 580 White Plains Road, Tarrytown, NY, 10591, US

(21) Appl. No.: 09/814,388

(22) Filed: Mar. 21, 2001

(30) Foreign Application Priority Data
Mar. 21, 2000 (GB) 0006678.7
Jul. 22, 2000 (GB) 0017977.0

(51) Int. Cl. H04N 7/167

(52) U.S. Cl. 380/210

(57) ABSTRACT

A message delivery system for delivering information services to a user having a display apparatus, such as a teletext television receiver (20), wherein an encrypted message including commands is transmitted as a SMS message in a pre-assigned teletext page. An enabled television receiver includes a client (22) for parsing the commands in the SMS message and uses the commands for conditioning the receiver as required in order to display the messages in a format similar to text signals.

The present invention relates to a method of, and means for, delivering information services over the air.

Information services between an internet server and a personal computer (PC) have existed for some years. Some of these services include information retrieval and business activities such as banking, insurance and electronic commerce, so called e-commerce. More recently there have been developments to enable the internet services to be available to users of portable telecommunications devices such as cellular telephones. For the most part these services have been the downloading of data for display on a display panel built into the device.

There is a growing demand for more internet services, such as user selectable subscription services, to be made available to users of other devices such as television receivers. It is known to use a television receiver as a video display unit of a domestic e-mail installation which includes a keyboard coupled by a link to an e-mail modem and to the television receiver. Although such systems are in use they require the user to have a separate keyboard and modem.

An object of the present invention is to simplify the transmission to, and reception of, information services to selective users having display apparatus such as television receivers.

According to a first aspect of the present invention there is provided a method of delivering information services to a display apparatus having the capability of receiving broadcast text services, comprising assigning at least one text page to the delivery of information services, receiving information, encrypting the information to include commands, formatting the encrypted information and commands as packet message signals, transmitting the formatted packet message signals as at least one text page, receiving the at least one text page, decrypting and parsing the packet message signal to recover the commands and using the commands to operate on and/or display the information as desired.

According to a second aspect of the present invention there is provided a system for delivering information services, comprising a source of information, means for encrypting the information to include commands, means for formatting the information and commands as packet message signals, a text center for incorporating the packet message signals into a predetermined text page and for transmitting said text page, a display apparatus including signal receiving means and a client for parsing commands in the packet message signals and means for conditioning the receiving means in response to the commands in order to operate on and/or display the information as desired.

According to a third aspect of the present invention there is provided a display apparatus having the capability of receiving broadcast text services, including a client for parsing commands present in packet message signals transmitted in at least one predetermined text page and means for conditioning the display apparatus in response to the commands.

According to a fourth aspect of the present invention there is provided apparatus for delivering information services to a user having a television receiver with the capability of receiving broadcast teletext services, the apparatus comprising a source of information, means for encrypting the information to include commands, means for formatting the information and commands as packet message signals, a teletext center for incorporating the packet message signals into a predetermined text page and for transmitting said text page.

According to a fifth aspect of the present invention there is provided a signal comprising a text page including at least one packet message signal including encrypted information and commands.

By supplying information services as a text page to a television receiver, a user can select the page at his/her own choosing and use the controls of a TV remote controller to navigate around the message(s) to be displayed.

The present invention will now be described, by way of example, with reference to the accompanying drawings, wherein:

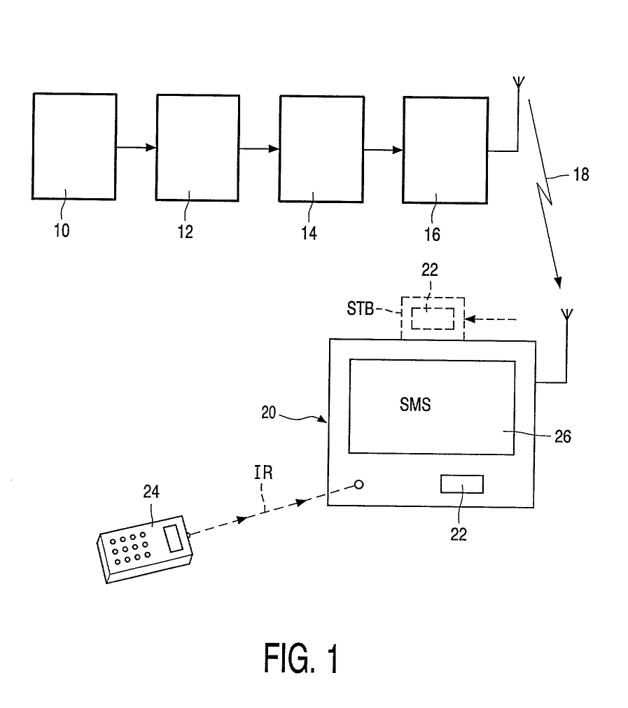

FIG. 1 is a block schematic diagram of an architecture of an information service delivery system for use in conjunction with a teletext television receiver, and

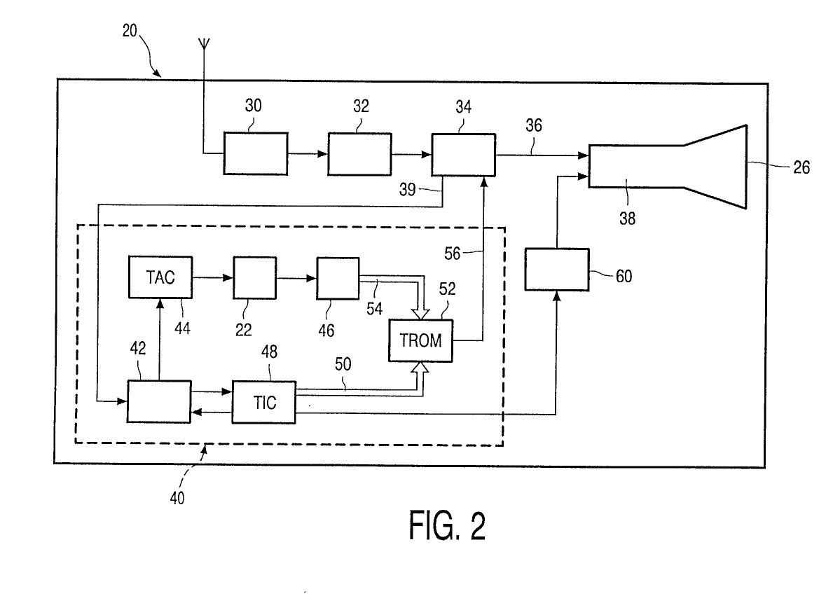

FIG. 2 is a block schematic diagram of a television receiver.

In the drawings the same reference numerals have been used to indicate corresponding features.

Referring to FIG. 1, the illustrated architecture comprises an information source comprising an internet server 10 which is coupled by a suitable link to a service provider 12. The service provider encrypts the information and adds commands which at a suitable display apparatus, such as a teletext television receiver 20, are parsed by a client 22 incorporated in the receiver and used to condition the display apparatus in order to operate on and/or display the information. The display apparatus may comprise an analogue television receiver, a digital television receiver or a combination of a television receiver and a set top box.

The output from the service provider 12 typically comprises short message service (SMS) messages, e-mail messages and/or other embedded messages. In the case of SMS messages these are formatted as byte stream data packet messages. These messages are relayed to a teletext center 14 where they are incorporated into a teletext page dedicated to the delivery of short messages to a display apparatus, such as a television receiver 20, incorporating a client 22 or to a set top box STB including a client 22. The client is in reality a software package stored in a processor which may be integrated into the receiver circuitry or comprise a separate module. The teletext pages are relayed to a television transmitter 16 for transmission as broadcast signals 18.

For convenience of description it will be assumed that the display apparatus is a television receiver. The broadcast signals 18 are picked-up by the receiver 20 which includes the client 22. The selection of the relevant teletext pages is controlled by a user having a remote controller 24 which can emit infra-red (IR) signals which are detected by a sensor 26 on the receiver 20. Once having selected the page(s) associated with a message service, the messages, excluding the commands which had been parsed in the processing of the teletext signals, are displayed on the television screen 26.

By embedding the client 22 in the television receiver 20 (or set top box STB) and associating it with a specific teletext page or pages then information such as e-mail messages, short messages and embedded messages can be relayed by the internet based server to the subscriber's television receiver 20 where they are displayed in the same format as teletext signals. A receiver 20 not having a client or suitably authorised client is unable to decrypt and recover the messages in the broadcast signal 18.

The television receiver shown in FIG. 2 comprises a rf receiver stage 30 whose output is coupled to a decoder 32. An output of the decoder 32 is coupled to a video signal processor 34 which has an output 36 coupled to a cathode ray tube 38 having a display screen 26. Another output 39 of the processor 34 provides a video signal to teletext circuitry 40.

The teletext circuitry 40 comprises a video processor 42 for recovering teletext signals which are transmitted in the field blanking interval of a broadcast television transmission in a manner known per se. A teletext data acquisition and control (TAC) stage 44 is coupled to an output of the video processor 42. A client 22 is coupled to the TAC stage 44 for decrypting a received message and parsing commands included in the transmission of the SMS teletext page. Any pages not including SMS messages are not affected by the client 22. The recovered teletext pages are stored in a memory 46.

In order to display teletext signals, various timing signals have to be derived from the video signal applied to the video processor 42. These timing signals are recovered by a timing chain stage or TIC stage 48. The TIC stage 48 has a parallel data bus 50 coupled to a teletext ROM (or TROM) 52. An output of the memory 46 is coupled by a parallel data bus 54 to another input of the TROM 42. The TROM 42 has an output 56 coupled to the signal processor 34. The TIC stage 48 has another output 58 coupled to a timebase stage 60 which supplies timing signals to the cathode ray tube 38.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of teletext television receiving apparatus and component parts therefor and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of delivering information services to a display apparatus having the capability of receiving broadcast text services, comprising assigning at least one text page to the delivery of information services, receiving information, encrypting the information to include commands, formatting the encrypted information and commands as packet message signals, transmitting the formatted packet message signals as at least one text page, receiving the at least one text page, decrypting and parsing the packet message signal to recover the commands and using the commands to operate on and/or display the information as desired.

2. A method as claimed in claim 1, characterised in that the packet message signals are formatted as short message service (SMS) signals.

3. A method as claimed in claim 1 or 2, characterised in that the packet message signal includes an information service identifier and in that a display apparatus is enabled by the information services identifier to receive information services transmitted in the at least one text page.

4. A system for delivering information services, comprising a source of information, means for encrypting the information to include commands, means for formatting the information and commands as packet message signals, a text center for incorporating the packet message signals into a predetermined text page and for transmitting said text page, a display apparatus including signal receiving means and a client for parsing commands in the packet message signals and means for conditioning the display apparatus in response to the commands in order to operate on and/or display the information as desired.

5. A display apparatus having the capability of receiving broadcast text services, including a client for parsing commands present in packet message signals transmitted in at least one predetermined text page and means for conditioning the display apparatus in response to the commands.

6. Apparatus for delivering information services to a user having a display apparatus with the capability of receiving broadcast text services, the apparatus comprising a source of information, means for encrypting the information to include commands, means for formatting the information and commands as packet message signals, a text center for incorporating the packet message signals into a predetermined text page and for transmitting said text page.

7. A signal comprising a text page including at least one packet message signal including encrypted information and commands.
